(19) United States
(12) Patent Application Publication
(10) Pub. No.: US 2022/0027250 A1
(43) Pub. Date: Jan. 27, 2022

(54) DEDUPLICATION ANALYSIS

(71) Applicant: EMC IP Holding Company LLC, Hopkinton, MA (US)

(72) Inventors: Arvind Petaru, Shrewsbury, MA (US); Andrew Shooman, Sharon, MA (US)

(73) Assignee: EMC IP Holding Company LLC, Hopkinton, MA (US)

(21) Appl. No.: 16/939,166

(22) Filed: Jul. 27, 2020

(51) Int. Cl. G06F 11/34; G06F 11/30; G06F 3/06

(52) U.S. Cl. CPC G06F 11/3428; G06F 11/302; G06F 3/0673; G06F 3/0641; G06F 3/0653; G06F 3/0608

(57) ABSTRACT

One or more aspects of the present disclosure relate to testing, analyzing, and optimizing one or more data dedup techniques implemented by a storage system. A workload is generated to include zero or more deduplication (dedup) data patterns and one or more unique data patterns according to a target dedup hit ratio. The workload is issued to a storage device. The storage device's performance corresponding to processing the one or more workloads is analyzed.

### BACKGROUND

A data storage system including storage arrays can provide block-based storage, file-based storage, or object storage. The storage arrays can use multiple drives in a collection to store a huge amount of data, which can be managed by a management system. The management systems can implement data deduplication (“dedup”) techniques to remove duplicate information from a dataset. The techniques can identify duplicate information by comparing the information to previously stored data. Accordingly, data dedup techniques can greatly increase a storage capacity of a data storage system by eliminating redundant data.

### SUMMARY

One or more aspects of the present disclosure relate to testing, analyzing, and optimizing one or more data dedup techniques implemented by a storage system. A workload is generated to include zero or more deduplication (dedup) data patterns and one or more unique data patterns according to a target dedup hit ratio. The workload is issued to a storage device. The storage device's performance corresponding to processing the one or more workloads is analyzed.

In embodiments, the target dedup hit ratio can correspond to a ratio between a number of repeated patterns and a total number of patterns.

In embodiments, a dedup hit can correspond to an input/output operation in the workload causing data to be served from a cache memory of the storage device.

In embodiments, a threshold for the generation of the zero or more dedup patterns with respect to the generation of the one or more unique data patterns can be determined.

In embodiments, a random number between zero and one can be generated.

In embodiments, the threshold can be compared with the random number.

In embodiments, a dedup pattern or a unique data pattern for inclusion in the workload can be generated based on the comparison between the threshold and the random number.

In embodiments, a dedup pattern for the workload can be generated if the random number is less than or equal to the threshold. Alternatively, a unique data pattern can be generated if the random number is greater than the threshold.

In embodiments, the generated patterns for the workload can be monitored. Further, the generation of data patterns can be controlled using a reduced dedup ratio in response to a ratio between the zero or more deduplication (dedup) data patterns and a total number of data patterns is consistent with the target dedup hit ratio.

In embodiments, either one or both of the one or more duplicated patterns and the unique patterns can be generated by obtaining one or more of: clock timestamp, computer process identification (ID), and a shift of n-bits of a host computer number.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a block diagram of a storage system in accordance with example embodiments disclosed herein.

FIG. 2 is a block diagram of a storage testing device in accordance with example embodiments disclosed herein.

FIG. 2A is a block diagram of a benchmarking tool in accordance with example embodiments disclosed herein.

FIG. 3 is a flow diagram of a method for data deduplication (“dedup”) analysis accordance with example embodiments disclosed herein.

FIG. 4 is a flow diagram of a method for generating dedup data workloads in accordance with example embodiments disclosed herein.

FIG. 5 is a flow diagram of a method for modifying data dedup workloads in accordance with example embodiments disclosed herein.

### DETAILED DESCRIPTION

Customers of storage systems such as those implemented as part of a storage area network (SAN) have unique data storage requirements and corresponding performance requirements (e.g. response time expectations). To increase their storage capacities, storage systems can implement one or more storage optimization techniques (e.g., data deduplication (“dedup”) techniques). Data dedup techniques can identify and eliminate duplicate data blocks. For example, data dedup techniques can compare incoming data with previously stored data to identify data copies. The techniques can then discard and replace the copies with a reference (e.g., pointer) to the previously stored copy.

For example, a typical email system might contain one hundred (100) instances of the same 1-megabyte (MB) file attachment. If the email platform is backed up or archived, all 100 instances are saved, requiring 100 MB of storage space. With data deduplication, only one instance of the attachment is stored; each subsequent instance is referenced back to the single saved copy. Accordingly, data dedup decreases a data storage requirement from 100 MB to one (1) MB. Thus, data dedup effectively increases a storage system's storage capacity. However, it is difficult to test and optimize data dedup techniques to ensure that a storage system not only meets each customer's storage capacity requirements, but also their performance requirements.

Embodiments of the present disclosure relate to testing, analyzing, and optimizing one or more data dedup techniques implemented by a storage system as described in greater detail herein.

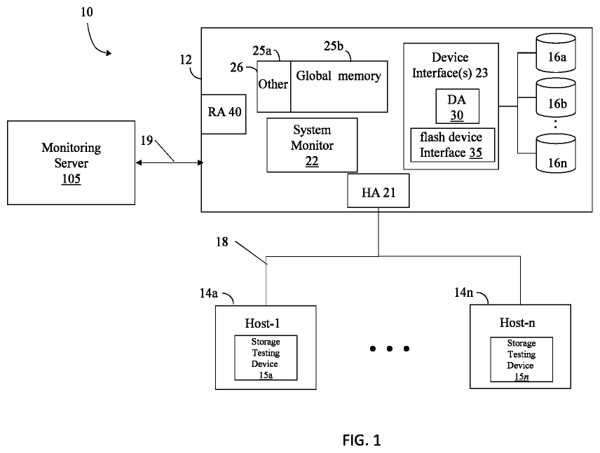

Referring to FIG. 1, an example system 10 includes data storage system 12. The system 12 is connected to host systems 14a-n and monitoring server 105 through respective communication mediums 18-19. In embodiments, the hosts 14a-n can access the data storage system 12, for example, to perform input/output (I/O) operations or data requests. As described in greater detail herein, each testing device 15a-n can reside on a respective host 14a-n. Each testing device 15-a-n can access the storage system 12 to perform deduplication testing and analysis. The communication mediums 18-19 can be any one or more of a variety of networks or other type of communication connections as known to those skilled in the art. In embodiments, the communication mediums 18-19 can be a network connection, bus, and/or other type of data link, such as a hardwire or other connections known in the art. For example, the communication mediums 18-19 can be the Internet, an intranet, network (including a Storage Area Network (SAN)) or other wireless or other hardwired connection(s) by which the hosts 14a-n can access and communicate with the data storage system 12. The hosts 14a-n can also communicate with other components included in the system 10 via the communication mediums 18-19.

Each host 14a-n and the data storage system 12 can be connected to the communication medium 18 by any one of a variety of connections as can be provided and supported in accordance with the type of communication medium 18. The processors included in the hosts 14a-n can be any one of a variety of proprietary or commercially available single or multi-processor system, such as an Intel-based processor, or other type of commercially available processor able to support traffic in accordance with each embodiment and application.

It should be noted that the examples of the hardware and software that can be included in the data storage system 12 are described herein in more detail and can vary with each embodiment. Each of the hosts 14a-n and data storage system 12 can all be located at the same physical site or can be located in different physical locations. Examples of the communication medium 18 that can be used to provide the different types of connections between the host computer systems and the data storage system of the system 10 can use a variety of different communication protocols such as SCSI, Fibre Channel, iSCSI, and the like. Some or all the connections by which the hosts 14a-n and data storage system 12 can be connected to the communication medium can pass through other communication devices, such switching equipment that can exist such as a phone line, a repeater, a multiplexer or even a satellite.

Each of the hosts 14a-n and testing devices 15a-n can perform different types of data operations in accordance with different types of tasks. In embodiments, any one of the hosts 14a-n and/or testing devices 15a-n can issue a data request to the data storage system 12 to perform a data operation. For example, an application executing on one of the hosts 14a-n and the testing devices 15a-n can perform a read or write operation resulting in one or more data requests to the data storage system 12.

It should be noted that although element 12 is illustrated as a single data storage system, such as a single data storage array, element 12 can also represent, for example, multiple data storage arrays alone, or in combination with, other data storage systems, systems, appliances, and/or components having suitable connectivity, such as in a SAN. It should also be noted that an embodiment can include data storage arrays or other components from one or more vendors. In subsequent examples illustrated the embodiments herein, reference can be made to a single data storage array by a vendor, such as by DELL Technologies of Hopkinton, Massachusetts. However, as will be appreciated by those skilled in the art, the embodiments herein are applicable for use with other data storage arrays by other vendors and with other components than as described herein for purposes of example.

The data storage system 12 can be a data storage array including a plurality of data storage devices 16a-n. The data storage devices 16a-n can include one or more data storage types such as, for example, one or more disk drives and/or one or more solid state drives (SSDs). An SSD is a data storage device that uses solid-state memory to store persistent data. An SSD using SRAM or DRAM, rather than flash memory, can also be referred to as a RAM drive. SSD can refer to solid state electronics devices as distinguished from electromechanical devices, such as hard drives, having moving parts. Flash devices or flash memory based SSDs are one type of SSD that contains no moving parts. The embodiments described herein can be used in an embodiment in which one or more of the devices 16a-n are flash drives or devices. More generally, the embodiments herein can also be used with any type of SSD although following paragraphs can refer to a particular type such as a flash device or flash memory device.

The storage system 12 can also include different types of adapters or directors, such as an HA 21 (host adapter), RA 40 (remote adapter), and/or device interface 23. Each of the adapters HA 21, RA 40 can be implemented using hardware including a processor with local memory with code stored thereon for execution in connection with performing different operations. The HA 21 can be used to manage communications and data operations between one or more host systems 14a-n and the global memory (GM) 25b. In an embodiment, the HA 21 can be a Fibre Channel Adapter (FA) or another adapter which facilitates host communication. The HA 21 can be characterized as a front-end component of the data storage system 12 which receives a request from one or more of the hosts 14a-n. The storage system 12 can include one or more RAs (e.g., RA 40) that can be used, for example, to facilitate communications between data storage arrays (e.g., between the storage array 12 and the external storage system(s)). The storage system 12 can also include one or more device interfaces 23 for facilitating data transfers to/from the data storage devices 16a-n. The data storage interfaces 23 can include device interface modules, for example, one or more disk adapters (DAs) 30 (e.g., disk controllers), flash drive interface 35, and the like. The DA 30 can be characterized as a back-end component of the data storage system 12 which interfaces with the physical data storage devices 16a-n.

One or more internal logical communication paths can exist between the device interfaces 23, the RAs 40, the HAs 21, and the memory 26. An embodiment, for example, can use one or more internal buses and/or communication modules. For example, the global memory 25b can be used to facilitate data transfers and other communications between the device interfaces, HAs and/or RAs in a data storage array. In one embodiment, the device interfaces 23 can perform data operations using a cache that can be included in the global memory 25b, for example, when communicating with other device interfaces and other components of the data storage array. The other portion 25a is that portion of memory that can be used in connection with other designations that can vary in accordance with each embodiment.

The data storage system as described in this embodiment, or a device thereof, such as a disk or aspects of a flash device, should not be construed as a limitation. Other types of commercially available data storage systems, as well as processors and hardware controlling access to these devices, can also be included in an embodiment.

Host systems 14a-n provide data and access control information through channels to the storage system 12, and the storage system 12 can also provide data to the host systems 14a-n also through the channels. The host systems 14a-n do not address the drives or devices 16a-n of the storage systems directly, but rather access to data can be provided to one or more host systems 14a-n from what the host systems view as a plurality of logical devices or logical volumes (LVs). The LVs do not need to correspond to the actual physical devices or drives 16a-n. For example, one or more LVs can reside on a single physical drive or multiple drives. Data in a single data storage system, such as a single storage system 12, can be accessed by multiple hosts allowing the hosts to share the data residing therein. The HA 21 can be used in connection with communications between a storage system 12 and one or more of the host systems 14a-n. The RA 40 can be used in facilitating communications between two or more data storage arrays (e.g., device 12 and external device(s) 105). The DA 30 can be one type of device interface used in connection with facilitating data transfers to/from the associated disk drive(s) 16a-n and LV(s) residing thereon. A flash device interface 35 can be another type of device interface used in connection with facilitating data transfers to/from the associated flash devices and LV(s) residing thereon. It should be noted that an embodiment can use the same or a different device interface for one or more different types of devices than as described herein.

The device interface, such as a DA 30, performs I/O operations on a drive 16a-n. In the following description, data residing on an LV can be accessed by the device interface following a data request in connection with I/O operations that other directors originate. Data can be accessed by LV in which a single device interface manages data requests in connection with the different one or more LVs that can reside on a drive 16a-n. For example, a device interface can be a DA 30 that accomplishes the foregoing by creating job records for the different LVs associated with a device. These different job records can be associated with the different LVs in a data structure stored and managed by each device interface.

A system monitor 22 can dynamically monitor the storage system 12 to collect a wide array of data (e.g. storage system telemetry data), both real-time/current and historical. Similarly, the system monitor 22 can receive similar data from the external storage system(s). The monitor 22 can transmit the collected telemetry data to a monitoring server 105, e.g., via communication medium 19.

In embodiments, the monitor 22 can collect data from the storage system and its components, e.g., Fibre channels. The components can include any of the elements 16a-n, 21-23, 25a-b, 26, 30, 35, and 40, amongst other known storage system components. Additionally, the monitor 22 can receive component data corresponding to one or more external device components from another storage system via RA 40. The collected data can be real-time and/or historical storage system telemetry data.

In embodiments, the monitoring server 105 can communicate with the data storage system 12 and hosts 14a-n through one or more connections such as a serial port, a parallel port, and a network interface card, for example, with an Ethernet connection. Using the Ethernet connection, for example, a device processor can communicate directly with DA 30, HA 21, and/or RA 40 of the data storage system 12. In other embodiments, the monitoring server 105 can be implemented via a cloud-based hosted solution (e.g., remote server) that communicates with the system 12 and/or the server 105 via a network (e.g., Internet, local area network (LAN), wide area network (WAN), amongst others).

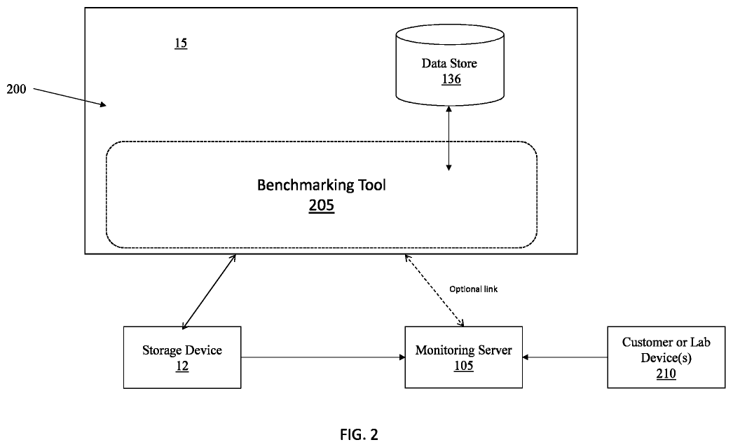

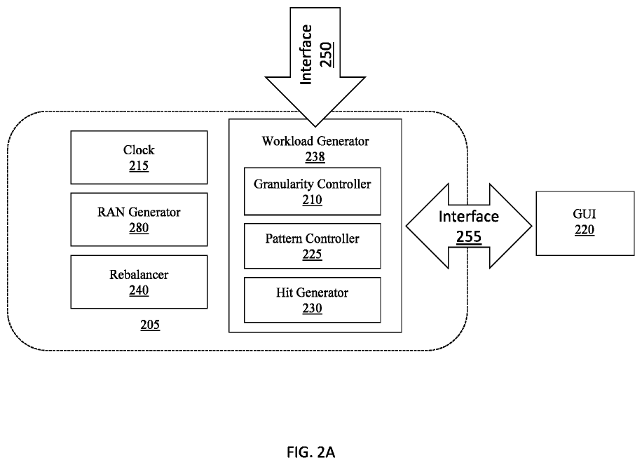

The storage testing devices 15a-n can include a benchmarking tool (e.g., tool 205 of FIG. 2) configured to test, analyze, and optimize one or more data dedup techniques implemented by the storage system 12. In embodiments, the testing devices 15a-n can generate workloads that can include dedup data patterns. The devices 15a-n can generate each workload based on a target dedup hit ratio. A deduplication hit (i.e., a dedup hit) corresponds to an I/O operation including a data pattern that has previously been stored in a cache (e.g., global memory 25b) of the storage device 12. Accordingly, a dedup hit ratio corresponds to a ratio between a number of repeated patterns and a total number of patterns in a workload.

The devices 15a-n can calculate the target dedup hit ratio based on arrays of data collected by the monitor 22 and/or monitors of one or more other storage systems. The other storage systems can include field deployed storage systems in use by one or more customers or those that are lab operated. Accordingly, the testing device can calculate the target dedup hit ratio based on real-world data and/or synthetic lab created data. In embodiments, the testing devices 15a-n can include one or more known machine learning (ML) techniques to process the data for the dedup hit ratio calculations. In other embodiments, the testing devices 15a-n can include an interface to enable a user to enter the target dedup hit ratio.

In embodiments, the testing devices 15a-n can further modify the generated workload to simulate real-world workloads (e.g., to introduce randomness that a customer deployed storage system can encounter). To ensure that the workload includes overall data patterns consistent with the target dedup hit ratio, the testing devices 15a-n can implement one or more dedup hit ratio generation techniques.

Although the storage testing devices 15a-n are depicted as existing external to the system 12, it should be noted that a storage testing devices 15a-n can exist within the system 12. Accordingly, the storage testing devices 15a-n can communicate with the data storage system 12 using any one of a variety of communication connections. The testing devices 15a-n are described in greater detail in the following paragraphs.

Referring to FIGS. 2-2A, a storage testing device 15 can receive storage system telemetry data corresponding to one or more customer deployed storage systems and/or lab operated storage systems 210 from server 105. In embodiments, the testing device 15 can include elements 200 (e.g., software and hardware/circuitry elements) configured to process the telemetry data as discussed herein. The testing device 15 can also be communicatively coupled to storage system 12 (e.g., such as system 12 of FIG. 1) via a communications medium (e.g., medium 18 of FIG. 1).

It should be noted that the elements 200 can be any one of a variety of commercially available processors, such as an Intel-based processor, and the like. In embodiments, elements 200 can be a parallel processor such as a graphical processing unit (GPU). Although what is described herein shows details of software/hardware that can reside in the storage testing device 15, all or portions of the illustrated components can also reside elsewhere such as on a storage system and/or storage system component (e.g., HA 21, DA 30, RA 40 of FIG. 1).

The testing device 15 can include a benchmarking tool 205 that comprises a workload generator 238 that can generate workloads. Each workload can include unique data patterns and/or dedup data patterns. In embodiments, a workload can include a combination of zero or more dedup patterns (e.g., repeated patterns) and one or more unique patterns. The combination can correspond to the target dedup hit ratio. The target dedup hit ratio can be defined as a ratio between a number of repeated patterns and a total number of patterns in a workload.

In embodiments, the generator 238 can generate unique patterns using one or more generator elements such as a clock timestamp (e.g., an n-bit hardware/software clock 215), a process identifier (ID) (e.g., a host computer process ID), and an i-bit shift of a computer number (e.g., a host computer number). Each tick of the clock can correspond to a time-unit that, in combination with one or more of the other generator elements, ensures that each generated pattern is unique. For example, the time-unit can correspond to one (1) nanosecond such that a period of a 64-bit hardware/software clock's repetition is approximately 2⁶⁴ nanosecond or 584 years.

In embodiments, the generator 230 can include a granularity controller 210 that can define a data unit size of each dedup pattern. For example, the controller 210 can identify a configuration of the storage system 12 to determine its dedup capabilities. Based on the system's dedup capabilities, the controller 210 can set the granularity for generating dedup data patterns. In other embodiments, the controller 210 can establish a GUI 220 to receive dedup data granularity from an external source (e.g., user input or AI input system).

In embodiments, the generator 238 can calculate the target dedup hit ratio (t_{dh}) based on data received from the server 105, e.g., via a communication interface 250. The data can include storage system telemetry data corresponding to one or more storage systems. The storage systems can include field deployed storage systems in use by one or more customers or those that are lab operated. The generator 238 can process the data using one or more known machine learning (ML) techniques to calculate the dedup hit ratio. In other embodiments, the testing device 15 can include a communication interface 255 enabling a user to enter the dedup hit ratio via, e.g., a graphical user interface (GUI) 220.

The generator 238 can further include a pattern controller 225 configured to generate the dedup patterns and the unique data patterns using the target dedup hit ratio. That pattern controller 210 can compute a number of dedup patterns and a number of unique patterns. For example, the pattern controller 225 can determine a hit ratio of dedup only patterns, ‘H’, as a function of the target dedup ratio, ‘t_{dh}’. Using the hit ratio, ‘H”, the pattern controller 225 can establish a threshold value, ‘T’, between a number of I/O operations including dedup patterns and I/O operations including unique patterns. Further, the pattern controller 225 can establish a ceiling for a maximum hit ratio of dedup only patterns, ‘max t_{dh}’, that can be generated. In embodiments, the pattern controller 225 the hit ratio, ‘H’, threshold value, ‘T’, and maximum hit ratio of dedup only patterns, ‘max t_{dh}’ can include logic and/or circuitry to compute a number of dedup patterns and a number of unique patterns to be generated according to the following equations:

H=(R−1)÷R (EQ. 1)

T=t_{dh}÷H (EQ. 2)

max t_{dh}=H, (EQ. 3)

where ‘H’ is a hit ratio of just dedup patterns, “R’ is a target dedup ratio, ‘T’ is a threshold between I/O operations with dedup patterns and I/O operations with unique data patterns, ‘t_{dh}’ is a target dedup hit ratio, and ‘max t_{dh}’ is a maximum hit ratio of dedup only patterns.

To simulate a real-world environment, the pattern controller 225 can generate either a dedup pattern or unique pattern using random numbers generated from a random number (RAN) generator 280. For example, the RAN generator 280 can be configured to generate a random number between ‘0’ and ‘1’. If the random number is less than or equal to the threshold ‘T’, the pattern controller 225 can generate a dedup pattern for insertion into the workload; otherwise, the controller 225 can generate a unique data pattern for insertion into the workload.

Per EQ 3, the target dedup hit ratio cannot exceed the target dedup hit ratio because I/O patterns including unique data patterns are always misses (i.e., do not have corresponding data previously stored in cache memory). To ensure the generation of dedup patterns do not exceed the target dedup hit ratio, the pattern controller 225 controls the generation of dedup patterns by generating data patterns using a reduced dedup ratio, generated by a the hit generator 230. For example, the pattern controller 225 can then generate either a dedup pattern or unique data pattern by comparing the random number to the reduced dedup ratio to lower the number of dedup patterns that it generates.

In embodiments, the hit generator 230 can include logic and/or circuitry to compute the reduced dedup ratio, ‘R’ according to the following equations:

R′=Total÷Unique (EQ. 4)

R′=Total÷(Total−Dedup Hits) (EQ. 5)

R′=1÷(T*H) (EQ. 6)

R′=1÷(1−tan), (EQ. 7)

where ‘R’ is the reduced dedup ratio, ‘Total’ is the total number of all patterns generated, ‘Unique’ is the total number of unique patterns generated, and ‘Dedup Hit’ is the total number of dedup hits.

In further embodiments, the pattern controller 225 can introduce a destaging delay into each generated workload. The destaging delay can correspond to a threshold number of patterns between a first duplicated pattern and a corresponding second duplicated pattern. The threshold number of patterns between the first duplicated pattern and the corresponding second duplicated pattern is set to prevent the storage system 12 from writing to write pending storage tracks. The pattern controller 225 can determine the threshold number using the telemetry data received from server 105. For example, system monitor 22 can determine an average time it takes for write destaging. By preventing writes to write pending tracks, the benchmarking tool 205 can prevent the storage system 12 from obtaining an unrealistic advantage with respect to workload performance. For example, duplicate patterns may not be detected in global memory 25b but can be detected on disk.

In embodiments, the pattern controller 225 can implement a round-robin data pattern order with respect to the repeated and unique patterns to ensure a threshold number of patterns appear between a first and second instance of a dedup pattern. For instance, a random ordering technique would not allow the pattern controller to ensure a specific destaging delay.

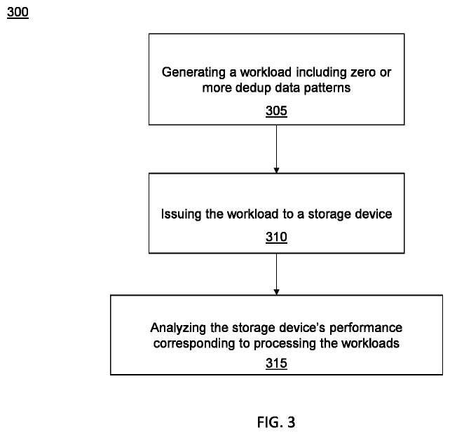

FIGS. 3-5 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts can be required to implement the methods in accordance with the disclosed subject matter.

Referring to FIG. 3, a method 300 can be performed by, e.g., a storage testing device such as storage testing device 15 of FIGS. 1-2.

The method 300, at 305, can include generating a workload including zero or more dedup data patterns and one or more unique data patterns. In embodiments, a combination of dedup data patterns and unique data patterns can be generated according to a target dedup hit ratio. At 310, the method 300 can include issuing the workload to a storage device. The method 300, at 315, can further include analyzing the storage device's performance in response to processing the workload.

A skilled artisan understands that the method 300 and any of its steps can be performed using any technique described herein.

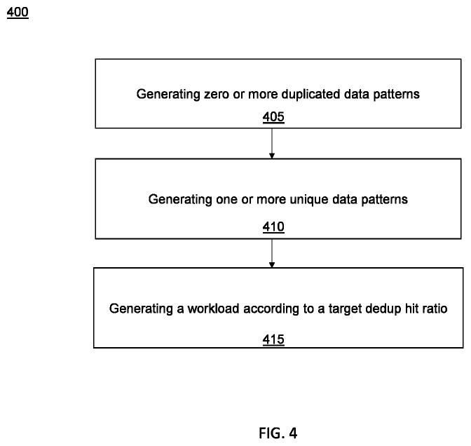

Referring to FIG. 4, a method 400 can be performed by, e.g., a storage testing device such as storage testing device 15 of FIGS. 1-2.

The method 400, at 405-410, can include generating zero or more duplicated patterns and one or more unique patterns. The method 400, at 415, can further include generating a workload including a combination of the duplicated patterns and unique patterns according to a target dedup hit ratio. The target dedup hit ratio can correspond to a ratio between a number of repeated patterns and a total number of patterns.

A skilled artisan understands that the method 400 and any of its steps can be performed using any technique described herein.

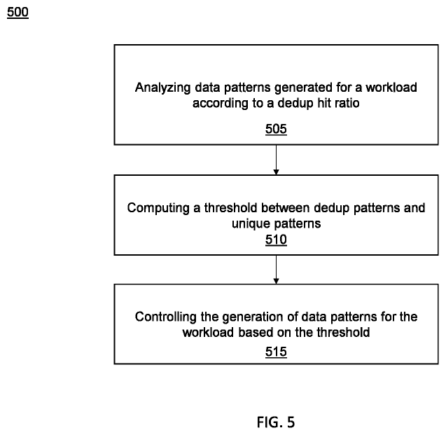

Regarding FIG. 5, a method 500 can be performed by, e.g., a storage testing device such as storage testing device 15 of FIGS. 1-2. The method 500, at 505, can include analyzing data patterns generated for a workload according to a dedup hit ratio. At 510, the method 500 can include computing the threshold between dedup patterns and unique patterns based on the analysis. The method 500, at 515, can further include controlling the generation of data patterns for the workload based on the threshold.

A skilled artisan understands that the method 500 and any of its steps can be performed using any technique described herein.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the concepts described herein by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random-access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the concepts described herein may be embodied in other specific forms without departing from the spirit or essential characteristics thereof. The foregoing embodiments are therefore to be considered in all respects illustrative rather than limiting of the concepts described herein. Scope of the concepts is thus indicated by the appended claims, rather than by the foregoing description, and all changes that come within the meaning and range of equivalency of the claims are therefore intended to be embraced therein.

What is claimed is:

1. An apparatus comprising at least one processor configured to:
generate a workload including zero or more deduplication (dedup) data patterns and one or more unique data patterns according to a target dedup hit ratio;
issue the workload a storage device; and
analyze the storage device's performance corresponding to processing workload.

2. The apparatus of claim 1, wherein the target dedup hit ratio corresponds to a ratio between a number of repeated patterns and a total number of patterns in the workload.

3. The apparatus of claim 1 wherein a dedup hit corresponds to an input/output operation in the workload causing data to be served from a cache memory of the storage device.

4. The apparatus of claim 1 further configured to determine a threshold for the generation of the zero or more dedup patterns with respect to the generation of a total number of data patterns.

5. The apparatus of claim 4 further configured to generate a random number between zero and one.

6. The apparatus of claim 5 further configured to compare the threshold with the random number.

7. The apparatus of claim 6 further configured to generate a dedup pattern or a unique data pattern for inclusion in the workload based on the comparison between the threshold and the random number.

8. The apparatus of claim 6 further configured to:
generate a dedup pattern for the workload if the random number is less than or equal to the threshold; and
generate a unique data pattern if the random number is greater than the threshold.

9. The apparatus of claim 8 further configured to:
monitor the generated patterns for the workload; and
control the generation of data patterns using a threshold between dedup and unique patterns in response to a ratio between the zero or more deduplication (dedup) data patterns and the total number of data patterns is inconsistent with the target dedup hit ratio.

10. The apparatus of claim 1, wherein generating either one or both of the one or more duplicated patterns and the unique patterns includes obtaining one or more of: clock timestamp, computer process identification (ID), and a shift of n-bits of a host computer number.

11. A method comprising:
generating a workload including zero or more deduplication (dedup) data patterns and one or more unique data patterns according to a target dedup hit ratio;
issuing the workload a storage device; and
analyzing the storage device's performance corresponding to processing workload.

12. The method of claim 1, wherein the target dedup hit ratio corresponds to a ratio between a number of repeated patterns and a total number of patterns in the workload.

13. The method of claim 1 wherein a dedup hit corresponds to an input/output operation in the workload causing data to be served from a cache memory of the storage device.

14. The method of claim 1 further comprising determining a threshold for the generation of the zero or more dedup patterns with respect to the generation of a total number of data patterns.

15. The method of claim 4 further comprising generating a random number between zero and one.

16. The method of claim 5 further comprising comparing the threshold with the random number.

17. The method of claim 6 further comprising generating a dedup pattern or a unique data pattern for inclusion in the workload based on the comparison between the threshold and the random number.

18. The method of claim 6 further comprising:
generating a dedup pattern for the workload if the random number is less than or equal to the threshold; and
generating a unique data pattern if the random number is greater than the threshold.

19. The method of claim 8 further comprising:
analyzing the generated patterns for the workload; and
controlling the generation of data patterns using a threshold between dedup and unique patterns in response to a ratio between the zero or more deduplication (dedup) data patterns and total number of data patterns is inconsistent with the target dedup hit ratio.

20. The method of claim 1, wherein generating either one or both of the one or more duplicated patterns and the unique patterns includes obtaining one or more of: clock timestamp, computer process identification (ID), and a shift of n-bits of a host computer number.
